(19) United States
(12) Patent Application Publication
(10) Pub. No.: US 2006/0078030 A1
(43) Pub. Date: Apr. 13, 2006

(54) Solid laser laterally pumped with focussed light from diodes in multiple flows

(76) Inventor: Konrad Altmann, Munich (DE)

Correspondence Address: SMITH-HILL AND BEDELL, P.C., 16100 NW CORNELL ROAD, SUITE 220, BEAVERTON, OR, 97006, US

(21) Appl. No.: 10/526,574

(22) PCT Filed: Sep. 2, 2003
(86) PCT No.: PCT/DE03/02905

§ 371 Date: Mar. 15, 2005

(30) Foreign Application Priority Data
Sep. 5, 2002 (DE) 102415471
Sep. 13, 2002 (DE) 102427011
May 5, 2003 (DE) 103202218

(51) Int. Cl. H01S 3/09

(52) U.S. Cl. 372/69; 372/71

(57) ABSTRACT

The invention relates to a solid laser, wherein a laser active material is pumped with the aid of at least one pump light source, e.g. of one of several laser diode arrays, at least in an approximately perpendicular manner in relation to the axis of a laser beam extending essentially inside said laser material. The pump beams are reproduced or focussed in said material with the aid of focusing optical elements, e.g. cylindrical lenses. At least one boundary surface, which is arranged opposite the incident surface, is provided in the material and is embodied in such a manner that the pump beams are reflected thereon and radiate once more through the laser material and/or such that an external reflector is arranged behind said opposite boundary surface and returns the pump beams into the material. The laser material can be doped in partial areas only.

Contrary to end-pumped rod lasers, with transverse or side-pumped lasers it is significantly more difficult to overlap pump light and laser mode optimally. In conventional systems the pump light coming from one or more pump light sources, e.g. diode arrays is either side beamed directly into a cylindrical crystal or focussed into the axis region of the crystal. In such assemblies the slow axis of the diode array is usually oriented parallel to the crystal axis. Since, after entering the crystal, the intensity of the pump light is diminished exponentially due to absorption, resulting in a considerable proportion of the pump power being aborbed in the direct vicinity of the entry location, wheras the laser mode forms in most assemblies along the crystal axis so that the distance between entry location and laser mode is at least of the order of 1 mm with crystal diameters as currently achievable, the overlap is weak and thus the efficiency of the laser low. Morover, because of the absorbed pump power being distributed unsymmetrically there is the problem that higher order transversal modes are excited to the detriment of beam quality.

Since, however, the latest pump light sources of interest, namely laser diode arrays having exceedingly slim elongated emitting surfaces make side-pumped systems superior in principle to end-pumped lasers, because of eliminating the expense of shaping the pump beam, it is the object of the present invention to create a substantial improvement by providing a laser of high beam quality making more efficient use of the incident pump power. This is now possible with the aid of an assembly as it reads from claim 1 of the present invention by surprisingly simple ways and means. Advantageous further embodiments of the invention read from the subject matter of the sub-claims.

In accordance with the invention the pump beam coming from a light source e.g. a laser diode array is beamed roughly perpendicular to the laser beam axis, but preferably slightly angled to the perpendicular of the surface of a laser material to enter into the latter. To ensure efficient utilization of the pump power the pump beam is focussed by optical elements such as e.g. lenses or mirrors on the laser material or an image of the emitting pump light surface area generated whose width is set to achieve good overlap of the pumped region and the laser beam. Since the side of the laser material facing away from the pump light source is preferably coated reflective, the pump light beam is reflected at the side of the laser material facing away from the pump light source to again pass therethru, resulting in a greater proportion of the pump power being absorbed. As an alternative or in addition to coating the laser material, a reflector, e.g. a mirror can be provided behind the facing away side of the laser material by which which the pump beam is reflected back into the material. The efficiency can be further enhanced considerably by returning or imaging the pump beam after having emerged from the laser material back into the material by a reflector, e.g. a mirror and then again reflected to the rear wall of the laser material, whereby the size and position of this second image is preferably selected to achieve good overlap with the laser beam. This why the second image is expediently located directly juxtaposed to the first image or coinciding therewith. It is in this way that the pump light beam is directed four times through the same pumped region of the laser material, resulting in highly effective utilization of the pump power. In an alternative version the second image of the pump beam is located at a certain distance away from the first and the pump beam, after having passed through a second region, is reflected back by the mirror into the first region. In this case it is expedient when a second pump beam passes through the two regions in another sequence. Where very weak absorbing materials are involved it may prove expedient to direct the pump beam in a similar way through two or more regions and also to direct the laser beam with the aid of diversion mirrors through all of these regions.

It is to be noted that when such indications in this patent as perpendicular or parallel are rendered relative by “approximately” or “substantial”, this means that the direction is mainly as indicated but that departures of e.g. 20 deg are just as possible.

The pump light source is configured preferably elongated, in other words extending significantly longer in one direction than in the other, or consisting of a train of small pump light sources along a preferred direction. Extending roughly parallel to the latter is also the pumped region along a preferred direction. The laser beam, which may also be folded, passes through the pumped regions preferably along this preferred direction in thus extending substantially between the surfaces of the laser material facing and facing away from the pump light source and thus also approximately parallel to the pump light source.

The laser material of the invention may be of any geometry adapted to the particular purpose, e.g. in the shape of a rod or slab. In the simplest case the material is slab-shaped, although it is proposed to achieve higher laser powers to employ rods of square or hexagonal cross-section, etc.

Cooling the laser material can be done both with the aid of a fluid flow and with the aid of a solid-state material of high thermal conductivity. Where a fluid flow is employed it is proposed to allow it to flow over the surfaces of the laser material facing and facing away from the pump light source and to dimension temperatures and/or cross-sections of the flow passages so that a symmetrical distribution of temperature and thus a symmetrical thermal lens materializes as best possible in the laser material through which the laser beam is directed.

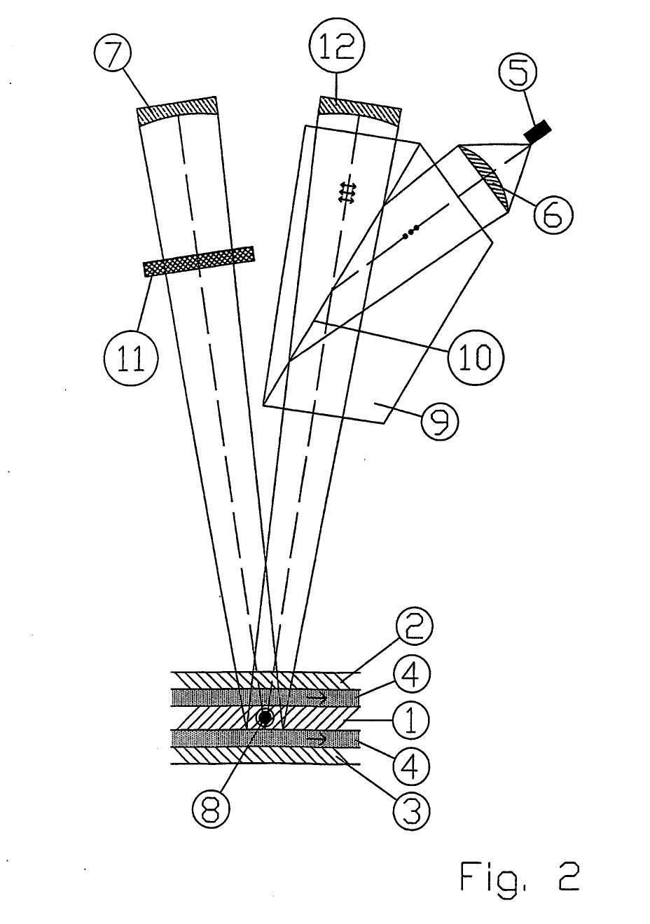

Using polarization and beam splitter elements as a function of the polarization achieves not reflecting the pump light beam back in the direction of the pump light source after the fourth passage through the laser material, it instead impinging a further reflector by which the beam is again returned back into the laser material. This is achieved by rotating the beam on its way in its direction of propagation, e.g. by lambda quarter slabs. Provided in front of the pump light source in this case is a polarization beam splitter which ensures that pump beam coming back from the laser material and rotated in the polarization plane takes a path different to that originally, i.e. it no longer being returned to the pump light source, but instead directed at a reflector by which it is in turn directed into the pumped region of the laser material. It is in this way that it is now possible to pass the pump beam through the pumped region eight times in all, as explained in more detail with reference to FIG. 2.

Instead of for a laser the invention can be employed just as well for a laser amplifier, it being proposed in this case that the side surface areas of the laser material are coated antireflective for possible laser wavelengths to prevent parasitic transversal modes materializing which would rob the pumped region of beam power. This can also be prevented as an alternative by lightly slanting opposite surfaces of the laser material and/or roughening the side surface areas.

Technical elements of the laser such as e.g. pump light sources, laser beams and optical elements may be provided singly or in a plurality. Where two linear pump light sources are used, these are arranged in line and/or staggered at an angle of preferably 90 deg.

Although the laser beam is aborbed in the laser material it may, however, emerge therefrom at the end faces located in the preferred direction of the pumped regions.

In one advantageous further embodiment of the invention as it reads from the main patent it is proposed to use a laser material which is doped only in internal regions. One preferred version thereof is shown in the FIG. in which the laser material takes the form of a slab made up of three layers, of which only the middle layer (25) is doped, whilst the top and bottom layers (24) are undoped. This results in the pump beam being aborbed only in the doped layer in thus achieving a better overlap between the pumped region and the laser mode. Propagation of the decaying portion of the laser mode, the evanescent wave, in the undoped regions is practically lossless.

The invention will now be detailled, for example, by way of preferred example embodiments with reference to the drawing in which:

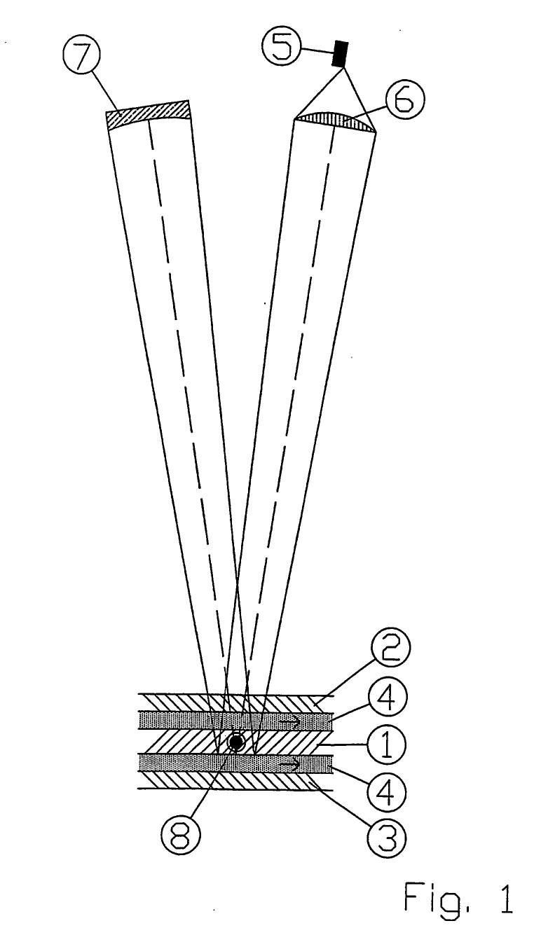

FIG. 1 is a section through an assembly in accordance with the invention transverse to the linear extent of the laser rod 1, configured as a slab on which a laser diode array 5 is imaged from above,

FIG. 2 is a section through an assembly in accordance with the invention transverse to the linear extent of the laser rod 1, configured as a slab on which a laser diode array 5 is imaged from above, whereby with the aid of a lambda quarter plate 11 and a polarization beam splitter the incident and back-reflected pump beam are separated so that the pump beam is directed through the slab eight times with the aid of mirrors,

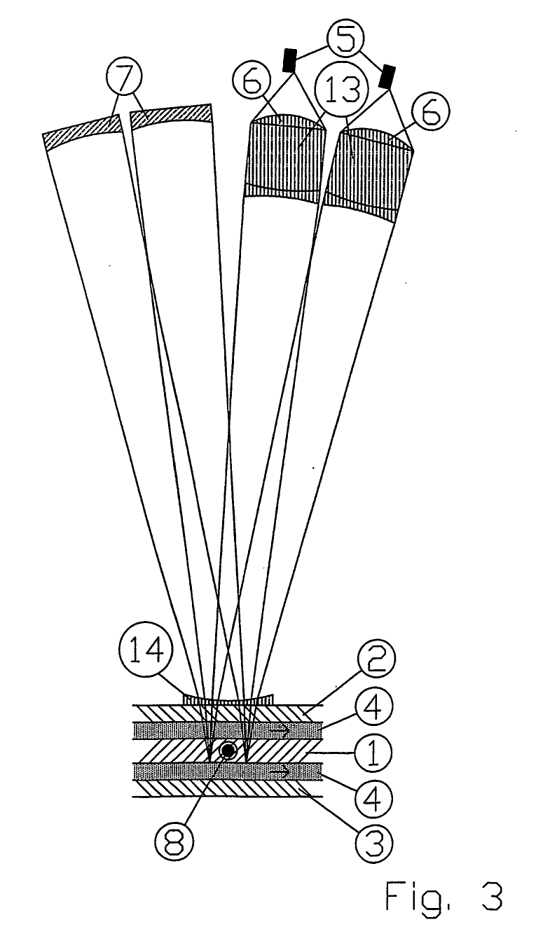

FIG. 3 is a section through an assembly in accordance with the invention transverse to the linear extent of the laser rod 1, configured as a slab on which two laser diodes 5 are imaged from above,

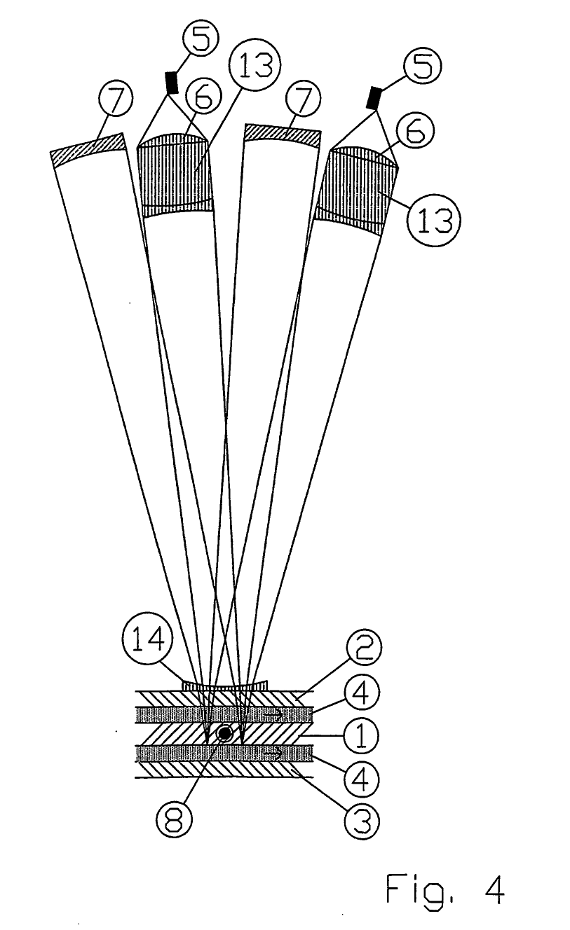

FIG. 4 is a section through an assembly as an alternative to that as shown in FIG. 3 on which laser diodes 5 and focussing lenses 13, on the one hand, and reflection mirrors 7, on the other, are arranged alternatingly as regards the perpendicular on the laser slab 1,

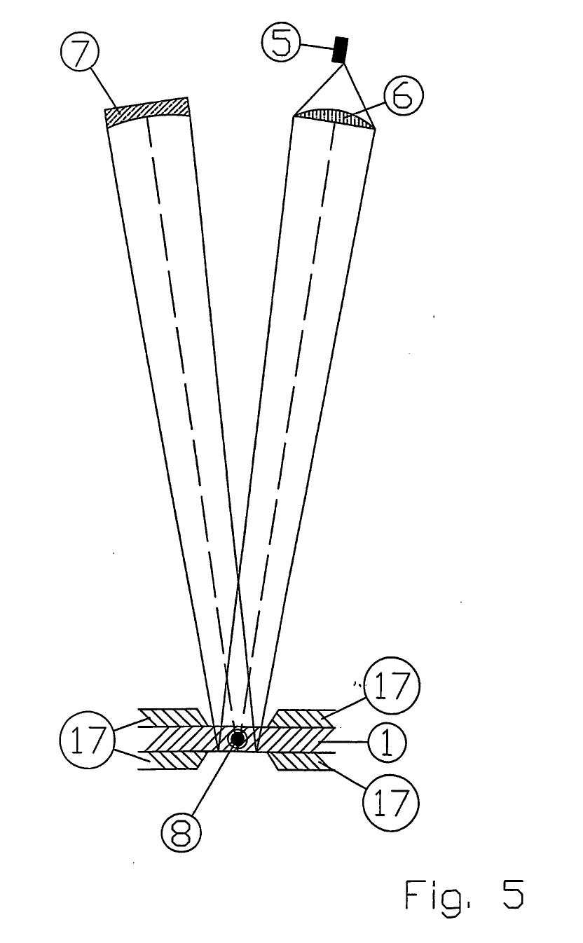

FIG. 5 is a section through an assembly in accordance with the invention transverse to the linear extent of the laser rod 1, configured as a slab on which unlike in FIG. 1 the fluid cooling is replaced by heat sinks of solid-state material.

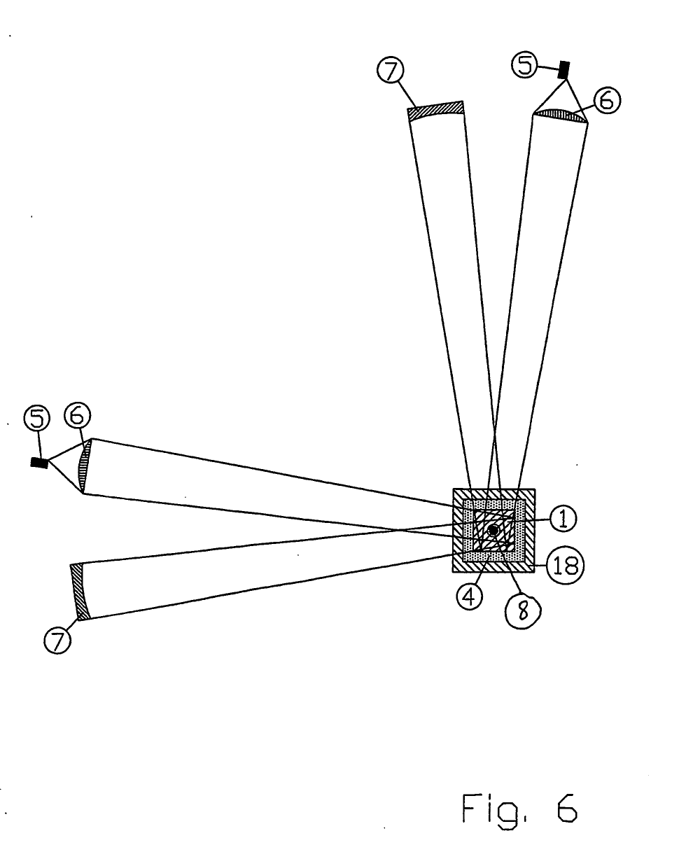

FIG. 6 is a section through an assembly in accordance with the invention in which the laser slab is additionally pumped from the left with the aid of a laser diode 5,

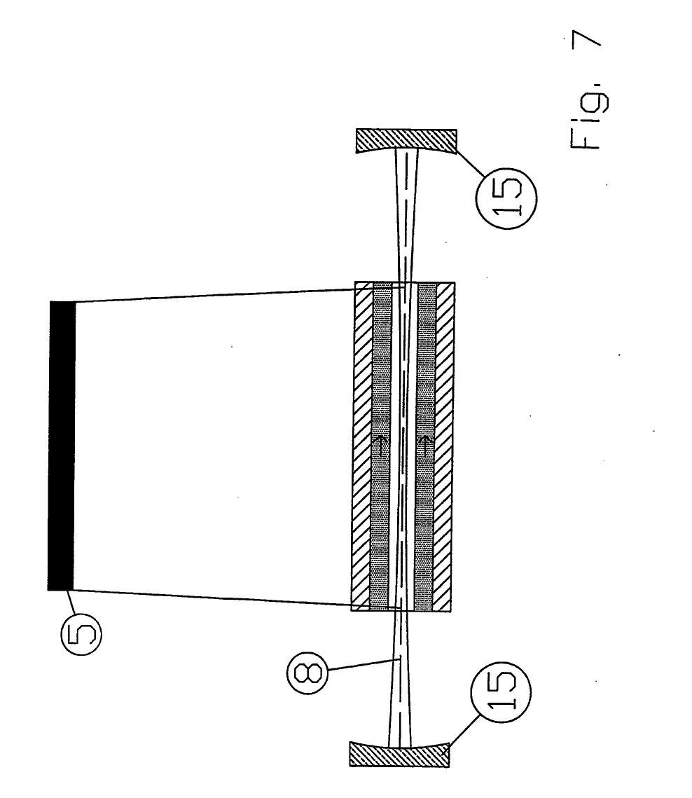

FIG. 7 is a section through a laser resonator in accordance with the invention including a laser rod 1 which is pumped from above by a pump diode 5.

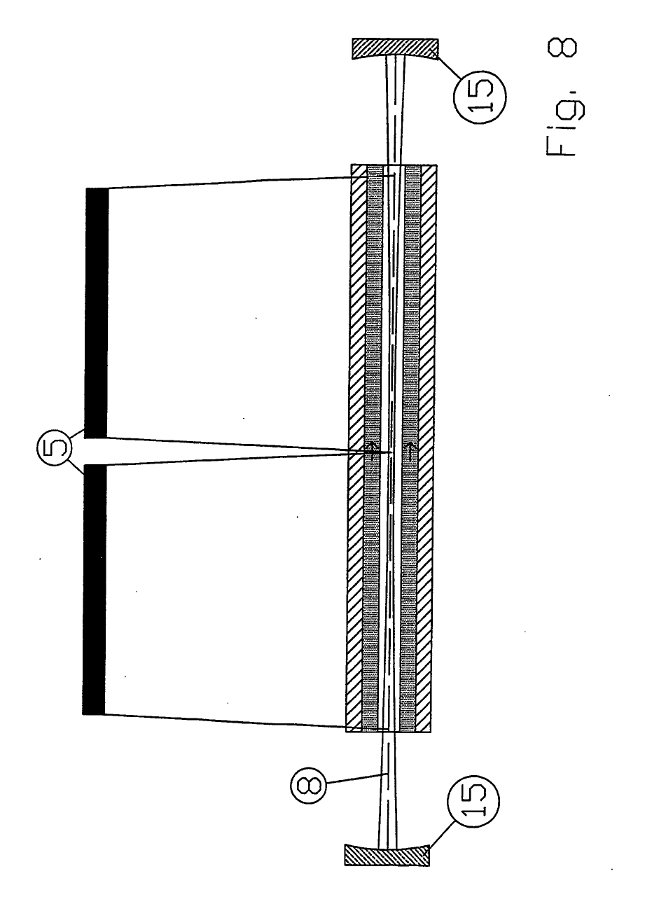

FIG. 8 is a section through a laser resonator in accordance with the invention including a laser rod which is pumped from above with two pump diodes arranged in line with the slow axis, and

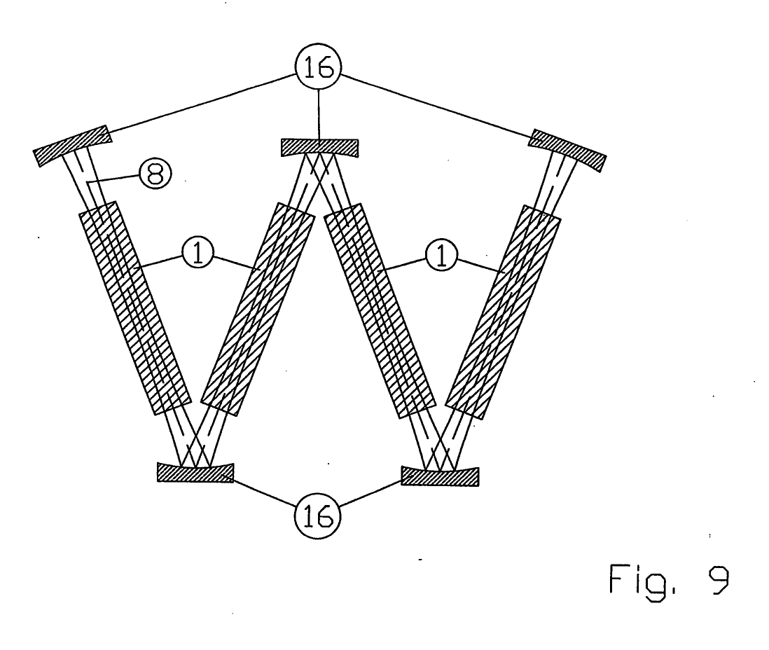

FIG. 9 is a section through a laser resonator in accordance with the invention in which the laser rods 1 are arranged in a zig-zag configuration,

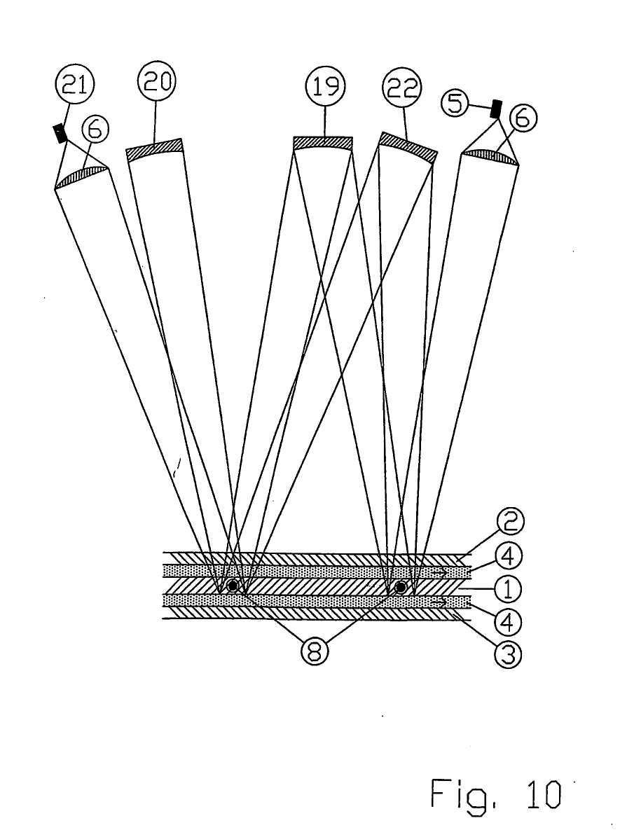

FIG. 10 is a section through an assembly in accordance with the invention in which the pump beam, after having left the laser slab from the top is imaged into a second region of the slab not coinciding with the first, from which it is reflected back and directed back into the first by mirrors,

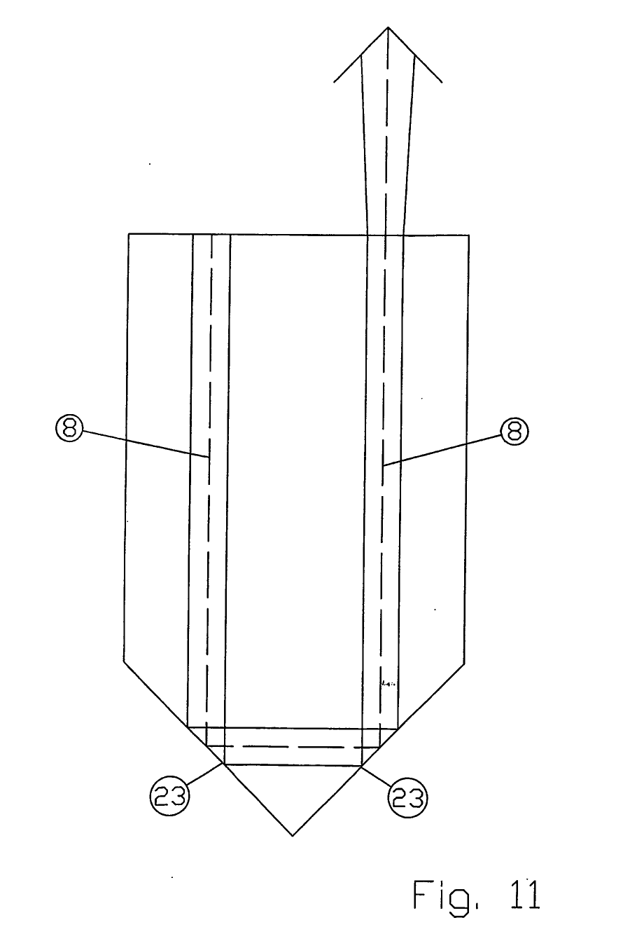

FIG. 11 is a section through a laser resonator in accordance with the invention transverse to the pump beams wherein the laser beam is directed by diversion mirrors through the two pumped regions as shown in FIG. 10.

Parts which are like, or like in function, are identified by like reference numerals in the FIGs.

Referring now to FIG. 1 there is illustrated unlike conventional assemblies a thin slab 1 of laser gain material between two plates 2 and 3 of glass or some other material transparent to the pump radiation. The interspaces between laser slab and glass plates are filled with a fluid coolant 4 which is likewise transparent to the pump radiation. The underside of the laser slab 1 is coated highly reflective for the pump radiation, whilst the upper side is coated antireflective. The pump beam coming from the diode array 5 is imaged with the aid of a cylindrical lens 6 curved in the direction of the fast axis of the diode array, through the upper glass slab and the coolant on the underside of the laser slab in a relatively narrow strip, the width of which is specified more accurately below as a function of other parameters. The angle of incidence formed by the axis of the pump beam to the normal on the pump light, is preferably roughly of the magnitude of half the aperture angle of the beam, but may also be larger or smaller than this. The reopening beam reflected at the underside of the laser slab impinges the cylindrically curved collimating lens 7 which re-images the beam on the underside of the pump light, the radius of curvature of the mirror being selected so that the second image of the beam is roughly the same in magnitude as the first and overlapping it. The beam is then again reflected at the underside of the laser slab in the direction of the cylindrical lens 6. Since the laser slab is passed through four times in this way, this assures that a considerable proportion of the pump radiation is absorbed in the slab, resulting in an occupany inversion being built up in the beamed region of the laser slab. The laser rod 8 is oriented roughly through the middle of the pumped region perpendicular to the imaging plane.

To further boost the efficiency of the pump assembly as described above, it is proposed to polarise the radiation of the laser diode. Referring now to FIG. 2 there is illustrated a corresponding assembly in accordance with the invention as will now be described. Unlike the assembly as shown in FIG. 1, in this version a polarization beam splitter 9, known as such, is inserted between the lens 6 and laser slab 1. Various embodiments of such beam splitters are available. For the assembly as shown in FIG. 2 e.g. a Foster prism was selected. This comprises two prismatically ground bodies of a strongly birefringent material, e.g. calcite, whose optical axis is oriented perpendicular to the image plane, resulting in the refractive index assuming a different value for baams polarized in or perpendicular to the imaging plane. The two bodies are joined together along an interface 10. Depending on the version involved either a narrow air gap between the bodies remains or the gap is filled with an optical cement whose refractive index is significantly smaller than the refractive index of the birefringent material. The polarized beam (• • •) coming from the laser diode 5, perpendicular to the image plane is in turn rendered convergent with the aid of a cylindrical lens, enters the Foster prism 9 from above on the right at a slanting angle. The angle at which the beam impinges the interface 10 is selected so that it is greater than the interface angle of total reflection, resulting in the pump beam being totally reflected at the interface 10 in then leaving the Foster prism in the direction of the laser slab. The refraction of the lens 6 is selected so that the pump beam is imaged, as shown in FIG. 1, as a narrow stripe on the underside of the laser slab where it is reflected and passes through, on its way to the mirror 7—now different to that as shown in FIG. 1—a lambda quarter plate 11 which converts the linear polarized light into circularly polarized light. Although on reflection at the mirror 7 the sense of rotation of the polarisation relative to the direction of propagation is maintained, but because of the latter reversing, the actual sense of rotation of the polarization also changes. Thus, although the beam impinging the lambda quarter plate from above is reconverted back into linear polarized light, but its direction of propagation is now rotated through 90° as compared to the original direction of propagation. The direction of propagation of the pump beam is thus in the image plane ( [symbol] [symbol] □) when the pump beam on its way to the laser slab has passed through the lambda quarter plate for a second time. This beam is then directed by the underside of the laser slab into the Foster prism, but, because the refractive index of the birefringent material for light polarized in the image plane is smaller, is no longer totally reflected at the interface 10, but passes through the latter with no change in direction and only minor losses in intensity. The beam then exits the Foster prism at the upper side is reflected back by the cylindrical mirror 12 into the Foster prism, imaged at the underside of the laser slab, redirected to the mirror 7 where it is reflected back to the laser slab. After its reflection at the mirror 12 the pump beam thus passes through the laser slab another four times, in other words it passing through the laser slab a total of eight times on its full way from the laser diode. This why in this version, unlike that as shown in FIG. 1, a significantly higher proportion of the pump radiation is absorbed in the laser slab, e.g. approximately 80% with Nd-YAG when using currently commercially available laser diodes and a slab thickness of 0.5 mm. As already mentioned above, many different versions are known for polarization beam splitters which are more or less suitable for the purpose of this assembly. The gist of this advantageous configuration of the invention is thus the achievement of additional passes of the pump beam through the laser slab with the aid of rotating the polarization plane and making use of polarization beam splitters.

Referring now to FIG. 3 there is illustrated how yet a further increase in the absorbed pump power is achieved by imaging the light of a plurality of laser diodes in the laser slab, FIG. 3 showing two laser diodes, although of course it is just as possible to image more than two diodes 5 in the laser slab by the principle as disclosed in FIG. 3. Since the aperture angle of the beam leaving the lens 6 is relatively small, when the distance between the lens and laser slab is selected correspondingly large, two or more lenses can be arranged juxtaposed, as shown in FIG. 3, for imaging the beams of the diodes on the laser slab. To further diminish the aperture angle of the beams and thus the angle of incidence of the outer beams, it is proposed to use instead of simple cylindrical lenses a system of lenses 12 for the purpose of reducing spherical aberrations. Since such systems of lenses are prior art, they are depicted in FIG. 3 merely diagrammatically. To further diminish the angle of incidence of the beams on the laser slab—meaning the angle formed by the beams to the perpendicular on the slab 1—it is proposed to additionally insert a cylindrically divergent lens 14 in the beam path in front of the upper glass plate 2. Unlike irradiation with just a single diode, irradiation with a plurality of diodes makes it possible to control the beam profile as arriving at the laser slab as a whole by definingly overlapping the profiles of the individual beams. To achieve this it is proposed to image the individual beams not exactly on each other but to slightly shift their beam profiles to the left or right somewhat to achieve in this way a more box-shaped overall profile to better approximate the resulting temperature distribution parabolically. To also achieve an eightfold multipass of the individual pump beams through the laser slab it is proposed, in this case too, to rotate the polarization planes of the individual pump beams with the aid of e.g. lambda quarter plates to separate the beam paths with the aid of polarization beam splitters and to reflect the rotated beams back to the laser slab with the aid of additional mirrors 12 analogous to the assembly as shown in FIG. 2. This alternative version is not depicted graphically, however.

Referring now to FIG. 4 there is illustrated how to facilitate the three-dimensional assembly of the elements and to render the transversal profile of the pump beam overall more symmetrical it is proposed to arrange laser diodes 5 and focussing lenses 13, on the one hand, and reflection mirrors 7, on the other, alternatingly as regards the perpendicular to the laser slab 1.

Referring now to FIG. 5 there is illustrated an assembly in accordance with the invention in which, unlike the assembly as shown in FIG. 1, fluid cooling is replaced by solid-state heat sinks of high thermal conductivity which in the form of four plates 17 cool the laser slab top and bottom. The gap between the two upper plates permits entry of the pump beam into the laser slab. To ensure that the resulting temperature distribution is symmetrical the two lower plates can be optionally separated by a gap.

Referring now to FIG. 6 there is illustrated how in increasing the total absorbed pump power still further, as is desirable e.g. for applications involving material processing, it is proposed to pump the laser rod not only from above but also from the left or right side or from below, in other words on several sides. In the assembly as shown in FIG. 6 a further laser diode 5 is imaged with the aid of a lens 6 from the left in the laser rod 1 whose cross-section is practically square, is reflected at the interface on the right and reflected back into the laser rod by a cylindrical lens 7 the same as with the irradiation already described above. The sides of the laser rod 1 are surrounded by a container, housing or case 18 transparent to the pump radiation. In the space between laser rod and case there is a flow of coolant 4. The laser beam 8 is formed within the rod lengthwise. To further boost performance it is also proposed in this case to insert polarization beam splitters and lambda quarter plates in the beam path and/or to irradiate with a plurality of diodes as already described with reference to FIGS. 2 to 4 for irradiation from above. To further increase the laser power it is proposed to use a laser rod hexagonal or octagonal in cross-section and to to irradiate it from correspondingly as many sides.

Designing the optical resonator depends on the properties of the laser material employed. With materials having a positive derivation dn/dT of the refractive index n in accordance with the temperature T such as Nd; YAG a more or less symmetrical thermal lens materializes along the pumped region, i.e. perpendicularly to the image plane as shown in FIGS. 1 to 6, in which the laser mode is guided as in a waveguide. In this case it is sufficient to grind the end faces of the slab oriented perpendicular to the pump region flat, to mirror-finish them and to use them as end faces for a laser resonator. Depending on the magnitude of the differential quotient dn/dT and the absorbed pump power the thermal lens effect may be so strong that the transversal profile of the laser beam becomes too narrow to adequately overlap the pumped region, resulting in a reduction in the efficiency of the laser. To prevent this, it is proposed to coat the flat end faces of the laser slab antireflecting for the laser radiation and to use separate end mirrors 15 for the laser resonator, as evident from FIG. 7. To render the design as simple as possible these external mirrors are preferably flat, although curved mirrors may prove advantageous, circumstances permitting. When a laser material is used in which the derivation of the refractive index according to the temperature disappears or becomes negative, curved end mirrors of the laser resonator will even be necessary. To control the overlap of pumped region and laser mode, it is further proposed as an alternative to optimze the width of the pumped region by altering the focal lengths of the lenses 6 and mirrors 7.

Referring now to FIG. 8 there is illustrated an assembly in accordance with the invention in which two linear pump sources, e.g. laser diode arrays 5 are arranged inline in the direction of the slow axis, whereby, of course, a plurality of diodes could likewise be arranged in the same way.

Referring now to FIG. 9 there is illustrated an assembly in accordance with the invention in the form of a folded resonator in which a plurality of laser slabs is arranged in a zig-zag formation between mirrors 16. The laser diodes (not shown) whose beams are imaged in the laser slabs analogous to the assemblies as shown in FIG. 1, 2 or 3 are located in front of the image plane perpendicularly above the slabs. As an alternative it is proposed to replace the individual slabs by a sole full-length slab, but with the laser diodes still in a zig-zag formation.

Referring now to FIG. 10 there is illustrated how to reduce the technical complications involved in achieving the assemblies as described above without diminishing the efficiency by an assembly attaining an eightfold multipass of the pump beam through a laser slab 1 without the aid of polarization beam splitters. For this purpose the pump beam emitted by the pump source 5 and imaged by the lens 6 on the laser material 1 after having left the laser slab 1 at the top, is imaged by a diversion mirror 19 on a region located to the left of the region first passed through. Here, the pump beam is re-reflected at the underside of the slab, directed to a mirror 20 which reflects it back into the second region before then being returned into the first region by the reflection of the diversion mirror 19. At the same time a second pump beam from the laser diode 21 is imaged by a lens 6 in the region on the left, reflected by the underside of the laser slab and, after having left the laser slab, is directed at a mirror 22 by which it is imaged in the pumped region on the right perpendicularly from above. In other words, after having been reflected at the underside of slab it is re-directed to the mirror 22 which images it again in the pumped region on the left. Thus, both pump beams pass through the two pumped regions eight-times each. As readily evident, it is not necessary that the second pump beam is imaged perpendicularly on the region to the right. If this is not the case, a further diversion mirror is required. Apart from this, it is possible to direct the pump beams with the aid of diversion mirrors through three or more juxtaposed regions as long as this makes sense technically for absorbing the pump beams. Shown in FIG. 11 is a resonator in accordance with the invention in which the laser beam is directed with the aid of diversion mirrors 23 through two pumped regions.

It is further proposed to make use of the assemblies as shown in FIGS. 1 to 11 for pumping and cooling laser rods for laser amplifiers by coupling an external laser beam from the face end along the pumped regions into the laser rod. To prevent parasitic transversal laser modes in the rods in this use of the invention, it is proposed to coat the side surfaces of the laser slabs or rods with an antireflective coating, as effective for the laser wavelengths in question, and to grind them not precisely parallel to each other. If the pump beams come exclusively from above it is proposed to roughen the right and left-hand side surface of the rod.

1-36. (canceled)

37. A solid-state laser or laser amplifier comprising:
a laser gain material for emitting a laser beam along an axis,
at least one pump light source for pumping the laser gain material with a pump beam that enters the laser gain material through an entry surface area along an axis at least approximately perpendicular to the axis of the laser beam, and
optical elements for focussing the pump beam in said laser material,
wherein the laser gain material has an entry surface area and at least one interface opposite the entry surface area, said interface being configured such that said pump beam is reflected by said interface to again pass through said laser gain material.

38. The solid-state laser as set forth in claim 37, comprising a reflector which receives said pump beam after reflection by said interface and directs said pump beam back into said laser gain material for a further time.

39. The solid-state laser as set forth in claim 38, wherein the reflector is a cylindrical mirror.

40. The solid-state laser as set forth in claim 38, wherein the optical elements and the reflector create respective images that overlap partly or fully.

41. The solid-state laser as set forth in claim 37, wherein said surface area through which said pump beam enters said laser gain material is flat.

42. The solid-state laser as set forth in claim 41, wherein said interface at which said pump beam is reflected is flat.

43. The solid-state laser as set forth in claim 42, wherein the axis of the laser beam is substantially parallel to said surface area and said interface.

44. The solid-state laser as set forth in claim 37, wherein said interface at which said pump beam is reflected is flat.

45. The solid-state laser as set forth in claim 37, wherein the pump beam is polarized in a first polarization state and the laser further comprises a reflector that receives said pump beam after reflection by said interface and directs said pump beam back into said laser gain material for a further time, and an optical element that is interposed between said laser gain material and said reflector and through which said pump beam passes when passing to and from the reflector and which alters the state of polarization of the pump beam to a second polarization state.

46. The solid-state laser as set forth in claim 45, wherein the pump beam is linearly polarized and the optical element interposed between said laser gain material and said reflector is a lambda quarter plate.

47. The solid-state laser as set forth in claim 45, further comprising a separating element located between the pump light source and the optical element that alters the polarization state of the pump light, wherein said separating element receives both pump light in the first polarization state and pump light in the second polarization state and directs the pump light in the first polarization state to the laser gain material and directs the pump light in the second polarization state to a reflector that reflects the pump light in the second polarization state to the laser gain material.

48. The solid-state laser as set forth in claim 47, wherein the separating element is a polarization beam splitter.

49. The solid-state laser as set forth in claim 37, comprising a plurality of linear pump light sources arranged perpendicularly to their linear extent and juxtaposed laterally, and wherein the pump light sources emit pump beams that impinge on said laser gain material at diverse angles of incidence.

50. The solid-state laser as set forth in claim 37, comprising a plurality of linear pump light sources arranged in line parallel to their linear extent for the purpose of pumping a stripe region of the laser gain material, said stripe region being of a length that is a multiple of the length of said individual pump light sources.

51. The solid-state laser as set forth in claim 50, wherein the plurality of pump light sources are separated from each other.

52. The solid-state laser as set forth in claim 50, wherein the plurality of pump light sources are arranged in groups.

53. The solid-state laser as set forth in claim 50, wherein said stripe region is composed of discrete segments.

54. The solid-state laser as set forth in claim 37, comprising at least two heat sink members of high thermal conductivity for cooling the laser gain material, the heat sink members being separated from each other by a gap that allows the pump light to enter the laser gain material.

55. The solid-state laser as set forth in claim 37, wherein the laser gain material is configured as a rod with at least two main surfaces each having an entry surface area, the rod has interfaces opposite the entry surface areas respectively, the laser comprises at least two pump light sources for pumping the laser gain material with respective pump light beams that enter the rod through said entry surfaces respectively, the laser further comprises optical elements for imaging the pump light sources into the laser gain material, and the interfaces are configured to reflect the pump beams that enter the rod through the respective entry surface areas to again pass through the laser gain material.

56. The solid-state laser as set forth in claim 37, characterized in that some or all of said technical elements defined in the preceding claims for imaging, redirecting, reflecting or polarizing said pump beams also find application for said beams coming from the other side(s).

57. The solid-state laser as set forth in claim 38, wherein the optical elements create an image in a first region of the laser gain material, the reflector creates an image in a second region of the laser gain material, and the laser comprises a further reflector that receives pump light reflected by the reflector, from the second region, and directs the received pump light to said first region.

58. The solid-state laser as set forth in claim 57, comprising a diversion reflector that receives pump light that has passed through said second region and directs the received pump light into a third adjacent region, and so on, to then be directed from said last region passed through in the reverse sequence through said regions as passed through prior.

59. The solid-state laser as set forth in claim 57, comprising a second pump light source that emits a second pump beam that passes through the second region, and a diversion reflector that receives the second pump beam from the second region and directs the second pump beam to the first region.

60. A solid-state laser or laser amplifier comprising:
a laser material having an entry surface area and at least one interface opposite the entry surface area,
at least one pump light source for pumping the laser material with a pump beam through said entry surface area along an axis at least approximately perpendicularly to the axis of a laser beam substantially absorbed in the laser material,
optical elements for focussing the pump beam in said laser material, and
an external reflector following said opposite interface for receiving said pump beam and reflecting said pump beam back into said laser material, whereby the pump beam again passes through the laser material.

61. The solid-state laser as set forth in claim 60, wherein the reflector is a cylindrical mirror.

62. The solid-state laser as set forth in claim 60, wherein the optical elements and the reflector create respective images that overlap partly or fully.

63. The solid-state laser as set forth in claim 60, wherein said surface area through which said pump beam enters said laser gain material is flat.

64. The solid-state laser as set forth in claim 63, wherein said interface is flat.

65. The solid-state laser as set forth in claim 64, wherein the axis of the laser beam is substantially parallel to said surface area and said interface.

66. The solid-state laser as set forth in claim 60, wherein said interface is flat.

67. The solid-state laser as set forth in claim 60, comprising a plurality of linear pump light sources arranged perpendicularly to their linear extent and juxtaposed laterally, and wherein the pump light sources emit pump beams that impinge on said laser gain material at diverse angles of incidence.

68. The solid-state laser as set forth in claim 60, comprising a plurality of linear pump light sources arranged in line parallel to their linear extent for the purpose of pumping a stripe region of the laser gain material, said stripe region being of a length that is a multiple of the length of said individual pump light sources.

69. The solid-state laser as set forth in claim 68, wherein the plurality of pump light sources are separated from each other.

70. The solid-state laser as set forth in claim 68, wherein the plurality of pump light sources are arranged in groups.

71. The solid-state laser as set forth in claim 60, comprising at least two heat sink members of high thermal conductivity for cooling the laser gain material, the heat sink members being separated from each other by a gap that allows the pump light to enter the laser gain material.

72. The solid-state laser as set forth in claim 60, wherein the optical elements create an image in a first region of the laser gain material, the reflector creates an image in a second region of the laser gain material, and the laser comprises a further reflector that receives pump light reflected by the reflector, from the second region, and directs the received pump light to said first region.

73. The solid-state laser as set forth in claim 72, comprising a diversion reflector that receives pump light that has passed through said second region and directs the received pump light into a third adjacent region, and so on, to then be directed from said last region passed through in the reverse sequence through said regions as passed through prior.

74. The solid-state laser as set forth in claim 72, comprising a second pump light source that emits a second pump beam that passes through the second region, and a diversion reflector that receives the second pump beam from the second region and directs the second pump beam to the first region.
